(19) United States
(12) Patent Application Publication
(10) Pub. No.: US 2022/0316433 A1
(43) Pub. Date: Oct. 6, 2022

(54) FUEL INJECTION SYSTEM FOR A VEHICLE AND FUEL RAIL FOR A FUEL INJECTION SYSTEM

(71) Applicant: Robert Bosch GmbH, Stuttgart (DE)

(72) Inventor: Joerg Jennes, Homburg (DE)

(21) Appl. No.: 17/714,214

(22) Filed: Apr. 6, 2022

(30) Foreign Application Priority Data
Apr. 6, 2021 (DE) 10 2021 203 373.3

(51) Int. Cl. F02M 55/02

(52) U.S. Cl. CPC F02M 55/025

(57) ABSTRACT

A fuel rail for a fuel injection system of a vehicle comprises a distributor pipe extending along a longitudinal axis, having at least one inlet connection for connection to a fuel pump and a plurality of outlet connections for connection to one injector each, which injectors are arranged along the longitudinal axis at a distance from the inlet connection, and a support projection which is arranged between the inlet connection and the outlet connections relative to the longitudinal axis, which projection protrudes in a radial direction extending transversely to the longitudinal axis into an interior of the distributor pipe. The fuel rail further comprises a throttle piece arranged in the interior of the distributor pipe, having a through-opening extending between a first and a second end face, which through-opening has a diameter which is smaller than an inside diameter of the distributor pipe on opposite sides of the support projection in each case. The first end face of the throttle piece is placed facing the inlet connection, an outer circumferential surface of the throttle piece abuts an inner circumferential surface of the distributor pipe, and the second end face of the throttle piece abuts the support projection.

### BACKGROUND OF THE INVENTION

The present invention relates to a fuel injection system for a vehicle and to a fuel rail for a fuel injection system.

In what are known as common rail injection systems, fuel is supplied at high pressure to a collector or distributor pipe by an inlet connection, e.g. by a high-pressure pump, and a plurality of injectors are connected to outlet connections of the distributor pipe. In this case, pressure fluctuations which can result from conveying the fuel using the high-pressure pump can occur within the distributor pipe.

DE 10 2006 003 639 A1 describes a fuel injection system comprising a distributor pipe which has an internal throttle arranged between an inlet connection and injector connections of the distributor pipe.

### SUMMARY OF THE INVENTION

According to the present invention, a fuel rail for a fuel injection system and a fuel injection system for a vehicle are provided.

A fuel rail according to the invention for a fuel injection system comprises a distributor pipe and a throttle piece. The distributor pipe extends along a longitudinal direction, in particular between a first and a second end, and comprises at least one inlet connection for connection to a fuel pump and a plurality of outlet connections for connection to one injector each. The injector connections are arranged along the longitudinal axis at a distance from the inlet connection. The distributor pipe further comprises a support projection which is arranged relative to the longitudinal axis between the at least one inlet connection and the outlet connections. That is to say, the support projection divides the distributor pipe into a first region in which the inlet connection or connections discharge into an interior of the distributor pipe, and a second region in which the outlet connections are connected to the interior of the distributor pipe. The support projection protrudes into the interior of the distributor pipe in a radial direction extending transversely to the longitudinal axis or extends into the interior in the radial direction.

The throttle piece is arranged in the interior of the distributor pipe and has a through-opening extending between a first and a second end face. The throttle piece can be for example in the form of an annular part. The through-opening has a preferably constant diameter which is smaller than an inside diameter of the distributor pipe on opposite sides of the support projection. That is to say, a first diameter defined by an inner circumferential surface of the distributor pipe in the first region and a second diameter defined by the inner circumferential surface of the distributor pipe in the second region are each greater than the diameter of the through-opening of the throttle piece. Fuel which flows from the inlet connection into the first region and through the through-opening into the second region of the distributor pipe thus undergoes a reduction in pressure as a result of the reduced diameter of the through-opening, which contributes in an advantageous manner to the reduction in pressure fluctuations in the second region.

According to the invention, the throttle piece is arranged in the first region of the distributor pipe, wherein the first end face of the throttle piece is placed facing the inlet connection, and an outer circumferential surface of the throttle piece abuts an inner circumferential surface of the distributor pipe, and the second end face of the distributor pipe abuts the support projection. An interference fit can advantageously be formed between the outer circumferential surface of the throttle piece and the inner circumferential surface of the distributor pipe.

According to the invention, the throttle piece is supported against the support projection along the longitudinal axis and is placed on a side of the support projection which faces the inlet connection. Therefore high-pressure fuel is applied to the first end face of the throttle piece facing the inlet connection, and therefore the throttle piece is pressed firmly against the support projection during operation. Advantageously, the support projection prevents the throttle piece from moving along the longitudinal axis towards the injector connections. A further advantage of the invention lies in the fact that the throttle piece is supported on the projection directly at the location of the load application by the fuel, as a result of which the load can be transmitted directly to the distributor pipe. In addition, a solution which has a simple design and is simple to assemble is provided, since the throttle piece does not necessarily have to be secured by additional elements, but rather the axial support against the projection, and optionally additionally the interference fit connection between the outer circumferential surface of the throttle piece and the inner circumferential surface of the distributor pipe are sufficient for securing the throttle piece.

According to another aspect of the invention, a fuel injection system for a vehicle comprises the fuel rail according to the invention, a fuel pump which is connected to the inlet connection of the fuel rail, and a plurality of injectors, wherein one injector is connected to one outlet connection of the fuel rail in each case. The fuel pump can be in particular a high-pressure pump which is configured to compress the fuel to a pressure in a range of between 250 bar and 3,500 bar.

Advantageous embodiments and developments can be found in the rest of the dependent claims and in the description with reference to the drawings.

According to some embodiments, it can be provided that the support projection is in the form of a continuous, circumferential projection. The support projection can thus be in the form of an uninterrupted frame surrounding the longitudinal axis. This further facilitates a uniform load introduction into the distributor pipe.

According to some embodiments, it can be provided that the distributor pipe has a first inside diameter on a side of the projection facing the inlet connection and a second inside diameter on a side of the projection facing the outlet connections which is smaller than the first inside diameter. Therefore the first region of the distributor pipe can have a larger diameter than the second region of the distributor pipe. Optionally, the first diameter and/or the second diameter can be in particular constant.

According to some embodiments, it can be provided that the support projection is formed in that the first inside diameter transitions into the second inside diameter in a step extending in the radial direction. The support projection can thus be formed by a support face extending perpendicularly to the inner circumferential surface of the distributor pipe in the radial direction, which face connects a first region of the inner circumferential surface which defines the first inside diameter to a second region of the inner circumferential surface which defines the second inside diameter. This design offers the advantage that the projection can be produced integrally with the distributor pipe in a simple manner, e.g. by drilling.

According to some embodiments, it can be provided that the inner circumferential surface of the distributor pipe defines a circular cross section. This is advantageous firstly in terms of the production of the projection by drilling or the like. Moreover, a circular cross section improves the pressure stability of the distributor pipe.

### BRIEF DESCRIPTION OF THE DRAWINGS

The invention will be described in the following with reference to the drawings, in which:

FIG. 1 is a schematic view of a fuel injection system according to one exemplary embodiment of the invention;

FIG. 2 is a schematic, cut-off, half-sectional view of a fuel rail according to one exemplary embodiment of the invention;

FIG. 3 is a detailed view of the region from FIG. 2 marked by the letter Z;

FIG. 4 is a plan view of an end face of a throttle piece of a fuel rail according to one exemplary embodiment of the invention; and

FIG. 5 is a sectional view of the throttle piece shown in FIG. 4.

### DETAILED DESCRIPTION

In the drawings, the same reference signs denote like or functionally like components, unless stated otherwise.

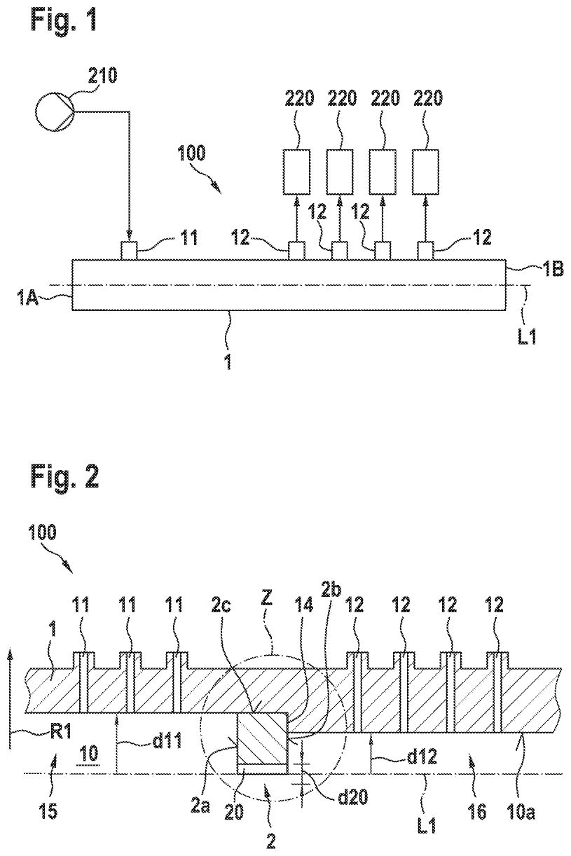

FIG. 1 shows, schematically and by way of example, a fuel injection system 200 for a vehicle, e.g. for a motor vehicle such as a car or a truck. As shown schematically in FIG. 1, the fuel injection system 200 comprises a fuel rail 100, a fuel pump 210 and a plurality of injectors 220. The fuel pump 210 is connected to an inlet connection 11 of the fuel rail 100, and one injector 220 is connected to one outlet connection 12 of the fuel rail 100 in each case. The fuel rail 100 forms a storage volume into which the fuel pump 210 conveys fuel at high pressure, e.g. in a range of between 250 bar and 3,500 bar. From the storage volume of the fuel rail 100, the fuel is supplied to the injectors 220 via the outlet connections 12, which injectors inject the fuel into a combustion chamber (not shown) of an internal combustion engine.

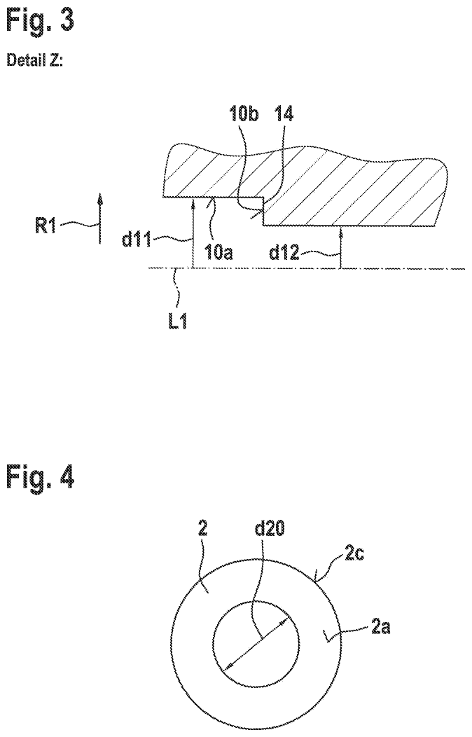

FIG. 2 shows by way of example a sectional view of a fuel rail 100 for a fuel injection system 200. FIG. 3 is a schematic, detailed view of the region marked by the letter Z in FIG. 2. As shown schematically in FIG. 2, the fuel rail 100 has a distributor pipe 1 and a throttle piece 2.

As shown schematically in FIG. 2 and also visible in FIG. 1, the distributor pipe 1 extends along a longitudinal axis L1 between a first and a second end 1A, 1B. In particular, the distributor pipe 1 defines an interior 10 which forms the storage volume. An inner circumferential surface 10a of the distributor pipe 1 surrounds the longitudinal axis L1 and defines the interior 10 in relation to a radial direction R1 which is perpendicular to the longitudinal axis L1. In particular, the inner circumferential surface 10a defines a cross-sectional shape and an inside diameter d11, d12 of the distributor pipe 1.

As further shown by way of example in FIG. 2, the distributor pipe 1 can have a plurality of, e.g. three inlet connections 11 for connection to the fuel pump 210. Generally, the distributor pipe 1 has at least one inlet connection 11. The distributor pipe 1 further has a plurality of outlet connections 12 for connection to one injector 220 each, e.g. four outlet connections 12, as shown by way of example in FIG. 2. Another number of outlet connections 12 is of course also conceivable. As shown schematically in FIG. 2, the inlet and outlet connections 11, 12 each form an opening in the distributor pipe 1, and therefore the interior 10 of the distributor pipe 1 can be connected in a fluidically conductive manner to the fuel pump 210 or the injectors 220 by the connections 11, 12. As shown schematically in FIG. 2 and also visible in FIG. 1, the outlet connections 12 are arranged along the longitudinal axis L1 at a distance from the at least one inlet connection 11. When a plurality of inlet connections 11 are provided, as shown purely by way of example in FIG. 2, these connections can be arranged in a group adjacently to one another along the longitudinal axis L1, wherein the outlet connections 12 can also be arranged in a group adjacently to one another, and the group of outlet connections 12 is arranged along the longitudinal axis L1 at a distance from the group of the inlet connections 11.

As shown by way of example in FIGS. 2 and 3, the distributor pipe 1 further has a support projection 14. The support projection 14 can be formed for example by a step extending in the radial direction R1, as shown schematically in FIGS. 2 and 3. The step can be formed for example by surface portion 10b, which extends perpendicularly to the longitudinal axis L1 and to the inner circumferential surface 10a of the distributor pipe 1, as shown schematically in FIGS. 2 and 3. In particular, the distributor pipe 1 can have a first region 15 having a first inside diameter d11 and a second region 16 adjoining this first region 15 can have a second inside diameter d12 which is smaller than the first inside diameter d11. For example, in each of the first and second regions 15, 16, the distributor pipe 1 can have a circular cross section defined by the inner circumferential surface 10a but is not limited thereto. In this case, the support projection is thus formed in that the first inside diameter d11 transitions into the second inside diameter d12 in a step extending in the radial direction R1. The support projection 14 can thus be in the form of a continuous, circumferential projection.

In principle, the support projection 14 can also be formed in another manner, e.g. by connecting pieces, pins or the like protruding radially from the inner circumferential surface 10a. It is also conceivable for a groove to be formed in the inner circumferential surface 10a, into which a spring washer is inserted. In general, the support projection 14 protrudes in a radial direction R1 extending transversely to the longitudinal axis L1 into an interior 10 of the distributor pipe 1.

As can also be seen in FIG. 2, the inlet connection(s) 11 is or are arranged in the first region 15 of the distributor pipe 1 or on a first side of the projection 14 in relation to the longitudinal axis L1, whereas the outlet connections 12 are arranged in the second region 16 of the distributor pipe 1 or on a second side of the projection 14 in relation to the longitudinal axis L1. The projection 14 is thus arranged between the at least one inlet connection 11 and the outlet connections 12 in relation to the longitudinal axis L1.

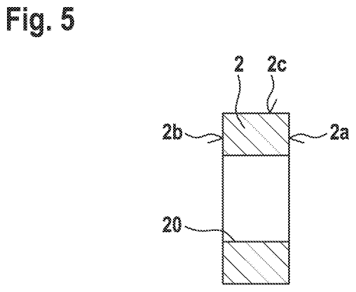

The throttle piece 2 is shown by way of example in FIGS. 4 and 5. As can be seen in FIG. 4, the throttle piece 2 can have for example an annular design. In general, the throttle piece 2 has a planar extent having a first end face 2a and a second end face 2b oriented oppositely thereto, wherein the first and second end faces 2a, 2b are connected by an outer circumferential surface 2c defining an outer circumference of the throttle piece 2. The outer circumferential surface 2c is formed so as to correspond to the inner circumferential surface 10a of the distributor pipe 1, e.g. in the shape of a circle as shown by way of example in FIG. 4. Furthermore, the throttle piece 2 has a through-opening 20 which extends between the first and second end faces 2a, 2b, as shown schematically in FIGS. 2 and 5. The through-opening 20 can have for example a circular cross section, as shown by way of example in FIG. 4.

As shown in FIG. 2, the throttle piece 10 is arranged in the interior 10 of the distributor pipe 1, in particular in the first region 15 or between the inlet connection 11 and the support projection 14 in relation to the longitudinal axis L1. As further shown schematically in FIG. 2, the first end face 2a of the throttle piece 2 is placed facing the inlet connection 11, and the second end face 2b is placed facing the outlet connections 12. Furthermore, the outer circumferential surface 2c of the throttle piece 2 abuts an inner circumferential surface 10a of the distributor pipe 1, and the second end face 2b of the throttle piece abuts the support projection 14. In particular, there can be a pressure contact between the outer circumferential surface 2c and the inner circumferential surface 10a of the distributor pipe 1 so that a frictional fit is formed between these surfaces. As can further be seen in FIG. 2, the through-opening 20 of the throttle piece 2 has a diameter d20 which is smaller than the first diameter d11 and smaller than the second diameter d12 of the distributor pipe 1. In general, the through-opening 20 has a diameter d20 which is smaller than an inside diameter d11, d12 of the distributor pipe 1 on sides of the support projection 14 which are opposite one another in relation to the longitudinal axis L1.

The throttle piece 2 thus forms an internal throttle in the distributor pipe 1, as a result of which pressure fluctuations in the second region 16 of the distributor pipe 1 are reduced when fuel flows through the through-opening or throttle opening 20 of the throttle piece 2 from the first region into the second region 15, 16 of the interior 10. Since the throttle piece 2 abuts the projection 14 arranged between the inlet connection 11 and the outlet connections 12 in the axial direction, an unwanted shift of the throttle piece 2 along the longitudinal axis L1 during the operation of the fuel injection system 200 is reliably counteracted.

Although the present invention has been described by way of example on the basis of exemplary embodiments, it is not restricted to these embodiments, but rather can be modified in various ways. In particular, combinations of the exemplary embodiments above are also conceivable.

1. A fuel rail (100) for a fuel injection system (200) of a vehicle, the fuel rail comprising:
a distributor pipe (1) extending along a longitudinal axis (L1), the distributor pipe comprising at least one inlet connection (11) for connection to a fuel pump (210) and a plurality of outlet connections (12) for connection to respective injectors (220), wherein the injectors are arranged along the longitudinal axis (L1) at a distance from the inlet connection (11), and a support projection (14) which is arranged between the at least one inlet connection (11) and the outlet connections (12) relative to the longitudinal axis (L1), wherein the projection protrudes in a radial direction (R1) extending transversely to the longitudinal axis (L1) into an interior (10) of the distributor pipe (1); and
a throttle piece (2) arranged in the interior (10) of the distributor pipe (1), the throttle piece having a through-opening (20) which extends between a first and a second end face (2a, 2b) and which has a diameter (d20) which is smaller than an inside diameter (d11, d12) of the distributor pipe (1) in each case on opposite sides of the support projection (14), wherein the first end face (2a) of the throttle piece (2) is placed so as to face the inlet connection (11), an outer circumferential surface (2c) of the throttle piece (2) abuts an inner circumferential surface (10a) of the distributor pipe (1), and the second end face (2b) of the throttle piece abuts the support projection (14).

2. The fuel rail (100) according to claim 1, wherein the support projection (14) is in the form of a continuous, circumferential projection.

3. The fuel rail (100) according to claim 1, wherein the distributor pipe (1) has a first inside diameter (d12) on a side of the projection (14) facing the inlet connection (11) and a second inside diameter (d12) on a side of the projection (14) facing the outlet connections (12), wherein the second inside diameter (d12) smaller than the first inside diameter (d11).

4. The fuel rail (100) according to claim 3, wherein the support projection (14) is formed in that the first inside diameter (d11) transitions into the second inside diameter (d12) in a step extending in the radial direction (R1).

5. The fuel rail (100) according to claim 1, wherein the inner circumferential surface (10a) of the distributor pipe (1) defines a circular cross section.

6. A fuel injection system (200) for a vehicle, comprising:
a fuel rail (100) according to claim 1;
a fuel pump (210) which is connected to the inlet connection (11) of the fuel rail (100); and
a plurality of injectors (220), wherein one injector (220) is connected to one outlet connection (12) of the fuel rail (100) in each case.

7. The fuel injection system (200) according to claim 6, wherein the support projection (14) is in the form of a continuous, circumferential projection.

8. The fuel injection system (200) according to claim 6, wherein the distributor pipe (1) has a first inside diameter (d12) on a side of the projection (14) facing the inlet connection (11) and a second inside diameter (d12) on a side of the projection (14) facing the outlet connections (12), wherein the second inside diameter (d12) is smaller than the first inside diameter (d11).

9. The fuel injection system (200) according to claim 8, wherein the support projection (14) is formed in that the first inside diameter (d11) transitions into the second inside diameter (d12) in a step extending in the radial direction (R1).

10. The fuel injection system (200) according to claim 6, wherein the inner circumferential surface (10a) of the distributor pipe (1) defines a circular cross section.

11. The fuel rail (100) according to claim 2, wherein the distributor pipe (1) has a first inside diameter (d12) on a side of the projection (14) facing the inlet connection (11) and a second inside diameter (d12) on a side of the projection (14) facing the outlet connections (12), wherein the second inside diameter (d12) is smaller than the first inside diameter (d11).

12. The fuel rail (100) according to claim 11, wherein the support projection (14) is formed in that the first inside diameter (d11) transitions into the second inside diameter (d12) in a step extending in the radial direction (R1).

13. The fuel rail (100) according to claim 12, wherein the inner circumferential surface (10a) of the distributor pipe (1) defines a circular cross section.
